(19) United States
(12) Patent Application Publication
(10) Pub. No.: US 2016/0092655 A1
(43) Pub. Date: Mar. 31, 2016

(54) METHOD AND APPARATUS FOR VOLUNTARY REPORTING

(71) Applicant: UMM AL-QURA UNIVERSITY, Makkah (SA)

(72) Inventor: Hassan HAZAZI, Hackensack, NJ (US)

(73) Assignee: UMM AL-QURA UNIVERSITY, Makkah (SA)

(21) Appl. No.: 14/394,207

(22) PCT Filed: Sep. 30, 2014
(86) PCT No.: PCT/IB2014/001975

§ 371 Date: Oct. 13, 2014

(51) Int. Cl. G06F 19/00

(52) U.S. Cl. CPC G06F 19/3487; G06F 19/322

(57) ABSTRACT

A voluntary reporting apparatus performs report generation and includes a check-in interface to receive patient identification information. The voluntary reporting apparatus determines whether a patient is taking a medication under study and receives side effects experienced by the patient related to the medication under study. The severity levels of the side effects are compared to severity level thresholds, and reports are generated that include the side effects and severity levels experienced by the patient related to the medication under study.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Before medications are approved by a food and drug administration (FDA), they go through sets of clinical trials to test their effectiveness. Patients volunteer to participate in clinical trials to assist the FDA and pharmaceutical companies in measuring how successful newly developed medications are at treating medical conditions. Patients who take the medications going through the clinical trials are evaluated for side effects, results, and overall effectiveness of the medications. If the FDA determines that the health benefits of the medication going through clinical trials are greater than the risks, the medication may be approved for widespread sale and distribution.

### SUMMARY

A voluntary reporting apparatus performs report generation and includes a check-in interface to receive patient identification information. The voluntary reporting apparatus determines whether a patient is taking a medication under study and receives side effects experienced by the patient related to the medication under study. The severity levels of the side effects are compared to severity level thresholds, and reports are generated that include the side effects and severity levels experienced by the patient related to the medication under study.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary network including a voluntary reporting apparatus, a database, and a plurality of servers, according to certain embodiments;

FIG. 2 illustrates an exemplary network for evaluating medications under study, according to certain embodiments;

FIG. 3 illustrates a non-limiting exemplary flowchart corresponding to a report generation process, according to certain embodiments;

FIG. 4A illustrates an exemplary initial check-in screen, according to certain embodiments;

FIG. 4B illustrates an exemplary patient information confirmation screen, according to certain embodiments;

FIG. 4C illustrates an exemplary appointment confirmation screen, according to certain embodiments;

FIG. 5A is an exemplary patient permission screen, according to certain embodiments;

FIG. 5B illustrates an exemplary legal notification screen, according to certain embodiments;

FIGS. 6A and 6B are exemplary illustrations of the patient medication information 600 for two exemplary patients, according to certain embodiments;

FIG. 7A and 7B are exemplary illustrations of side effect data that are stored in the patient database, according to certain embodiments;

FIG. 8A illustrates an exemplary side effect selection screen, according to certain embodiments;

FIG. 8B illustrates an exemplary side effect input screen, according to certain embodiments;

FIG. 8C illustrates an exemplary side effect severity screen, according to certain embodiments;

FIG. 8D illustrates an exemplary side effect warning screen, according to certain embodiments; and

FIG. 9 illustrates a non-limiting example of a voluntary reporting apparatus, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Referring now to the drawings, wherein like reference numerals designate identical or corresponding parts throughout the several views, the following description relates to a device and associated methodology for tracking the voluntary reporting of effects of medications. In certain embodiments, a voluntary reporting apparatus tracks the side effects of medications under study or clinical trials on patients who are taking the medications. Specifically, when a patient checks in for a doctor's appointment at a device such as a Smart Kiosk, the patient's medical record is retrieved from a database. If the patient is taking a medication under study, the patient has the opportunity to report the side effects of the medications that he or she is experiencing.

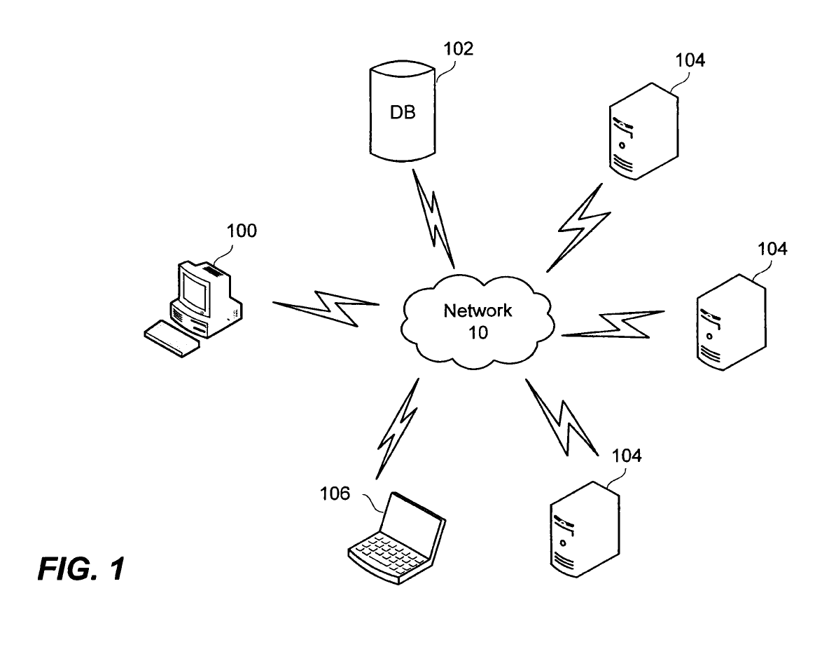

FIG. 1 illustrates an exemplary network including a voluntary reporting apparatus, a database, and a plurality of servers, according to certain embodiments. A voluntary reporting apparatus 100 acts as a client device that is connected to a server 104, a database 102 and a mobile device 106 via a network 10. The server 104 represents one or more servers connected to the voluntary reporting apparatus 100, the database 102 and the mobile device 106 via the network 10. The voluntary reporting apparatus 100 may interchangeably be known as the computer as described further herein. The database 102 represents one or more databases connected to the voluntary reporting apparatus 100, the server 104 and the mobile device 106 via network 10. In some embodiments, the database 102 can be a part of the one or more servers 104. The mobile device 106 represents one or more mobile devices connected to the voluntary reporting apparatus 100, the server 104 and the database 102 via the network 10. The network 10 represents one or more networks, such as the Internet, connecting the voluntary reporting apparatus 100, the server 104, the database 102 and the mobile device 106.

The voluntary reporting apparatus 100 includes a check-in interface, such as a keyboard and/or mouse, allowing a user, such as a patient, to input patient identification information, a file number, an appointment time, a doctor, and/or information pertaining to the condition for which the patient is being treated which is then transmitted to the server 104 via network 10. In selected embodiments, patient identification information can include name, age, birth date, last appointment date, treating physician, and/or primary ailment. In selected embodiments, the patient identification information can be retrieved from the database 102 by correlating a patient identification number, an identification card barcode, or biometric data such as a fingerprint with patient identification information previously stored in the database 102.

Once the patient identification information is received by the voluntary reporting apparatus 100, a query of the database 102 via the network 10 is conducted by a processor, which includes processing circuitry, to complete a report generation process. The database 102 can store categorical sets of data pertaining to a wide variety of medical issues, patient medical records, and treatments for the medical issues. In certain embodiments, the database 102 can store information pertaining to medications that are under study or in clinical trials. Examples of the trial medical data can include dosage levels, drug incompatibilities, and side effect data based on patient age, time of year when the patient started taking the medication, and dosage level. The report generation process can include, in selected embodiments, completing the patient check-in process, determining if the patient is taking a medication under study, retrieving potential side effects from the medication from the database 102, questioning the patient regarding the side effects he or she is experiencing, and generating reports based on the side effects that the patient reports. The details of the report generation process are discussed further herein. The copy of the report pertaining the patient side effects is also saved in memory of the server 104, database 102, and/or voluntary reporting apparatus 100/mobile device 106 and can be displayed on the display screen of voluntary reporting apparatus 100 and can also be sent to a variety of external devices, such as a mobile device 106, via text, email, or any other related method.

Based on the teachings herein, the mobile device 106 or any other external device could also be used in the same manner as the computer 100 to receive the patient identification information from an interface and send the patient identification information to the server 104 and database 102 via network 10 to complete the report generation process. In one implementation, a user, such as a patient, uses an application on his or her Smart Phone to check-in for a doctor's appointment and/or report side effects associated with a medication under study.

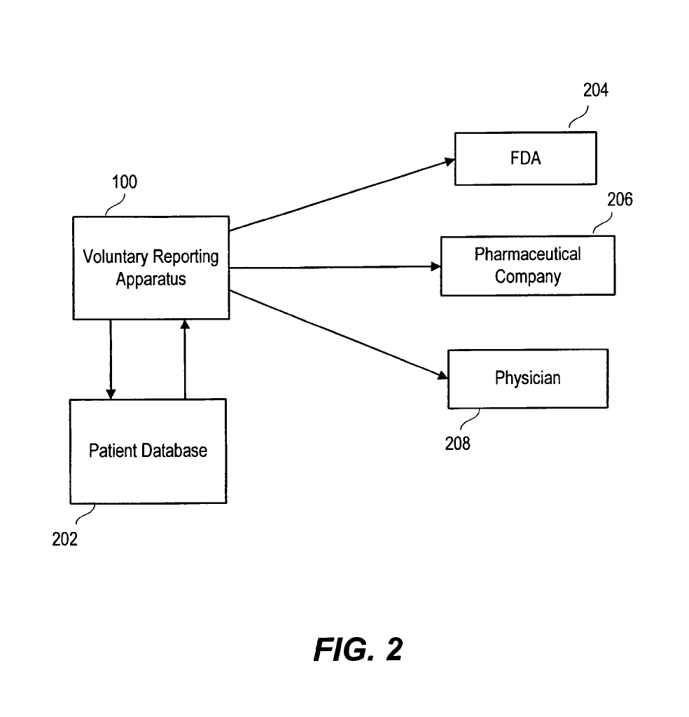

FIG. 2 illustrates an exemplary network for evaluating medications under study according to certain embodiments. In some implementations, the voluntary reporting apparatus 100 can be located at a clinic, hospital, or doctor's office. The voluntary reporting apparatus 100 may interchangeably be known as a self-check-in kiosk as described further herein. The patient can go directly to the self-check-in kiosk 100 to check-in for an appointment. The self-check-in kiosk 100 can include an interface, such as a keyboard and/or mouse, allowing a user, such as a patient, to input patient identification information, an appointment time, a doctor, and/or information pertaining to the condition the patient is being treated which is then correlated with data stored in patient database 202. In selected embodiments, patient identification information can include name, age, birth date, last appointment date, treating physician, and/or primary ailment. In certain implementations, the patient identification information can be retrieved from a patient database 202 by correlating a patient identification number, an identification card barcode, or biometric data such as a fingerprint with patient identification information previously stored in the patient database 202.

Once the patient identification information is received by the self-check-in kiosk 100, a query of the patient database 202 is executed by the processing circuitry. The patient database 202 can store categorical sets of data pertaining to a wide variety of medical issues, patient medical records, and treatments for the medical issues. In certain embodiments, the patient database 202 can store information pertaining to medications that are under study or in clinical trials, which can include dosage levels, drug incompatibilities, and potential side effects based on patient age, time of year when the patient started taking the medication, and dosage level. The report generation process can include, in selected embodiments, completing the patient check-in process, determining if the patient is taking a medication under study, retrieving potential side effects from the medication from the patient database 202, questioning the patient regarding the side effects he or she is experiencing, and generating reports based on the side effects that the patient reports. The details of the report generation process are discussed further herein. The copy of the report pertaining to the patient side effects is also saved in the memory of the self-check-in kiosk 100 and/or patient database 202 and can be displayed on the display screen of self-check-in kiosk 100 and can also be sent to a variety of external devices, such as a mobile device 106, via text, email, or any other related method.

Based on the teachings herein, the mobile device 106 or any other external device could also be used in the same manner as the self-check-in kiosk 100 to receive the patient identification information from an interface and send the patient identification information to the server 104 and patient database 202 via network 10 to complete the report generation process. In one implementation, a user, such as a patient, uses an application on his or her Smart Phone to check-in for a doctor's appointment and/or report side effects associated with a medication under study.

The self-check-in kiosk 100 can distribute the reports pertaining to the patient side effects via the network 10 to a variety of servers 104 that belong to one or more organizations that have an interest in knowing the information pertaining to the side effects that the patient is experiencing with respect to the medication under study. For example, in certain embodiments, the report can be sent to the patient database 202 to be stored in the patient's medical record. In some implementations, the report can be distributed to the server of a medication regulation organization, such as a food and drug administration 204, that may be responsible for approving the medication under study. For example, by directly receiving reports of patient side effects from medications under study, the food and drug administration 204 is able to monitor the safety of the new medications and evaluate their safety and effectiveness based on information provided directly from the patient.

In addition, the self-check-in kiosk 100 can also distribute the report pertaining to the patient side effects to the server of a pharmaceutical company 206 that developed the medication under study. For example, by directly receiving reports of patient side effects from medications under study, the pharmaceutical company 206 can study the medications in light of the side effects reported by the patients. In some implementations, the pharmaceutical company 206 can confirm the causes of the side effects, alter the composition of medications based on the reported side effects, and develop new drugs based on knowledge gained from knowing the side effects associated with different medications. In addition, the pharmaceutical company 206 can also use the patient side effect information from the report to assist in finding new applications for drugs that have already been developed. In certain embodiments, by sending the same reports to the pharmaceutical company 206 and the food and drug administration 204, there is an increase in transparency between pharmaceutical company 206 and the food and drug administration 204, which can decrease an amount of fraudulent reporting.

The self-check-in kiosk 100 can also distribute the report pertaining to the patient side effects to the server of a healthcare provider, such as a physician 208 or other medical professional who is providing medical services to the patient. For example, by directly receiving reports of patient side effects from medications under study, the physician 208 can evaluate the side effects the patient is experiencing and correlate them with the medication under study that the patient is taking. In addition, questioning the patient at the self-check-in kiosk 100 regarding the side effects associated with the medication under study prior to an appointment adds redundancy to ensure that the physician does not forget to question the patient regarding the side effects. In one implementation, the patient uses the application on his or her Smart Phone to report a side effect that immediately is sent to the physician 208.

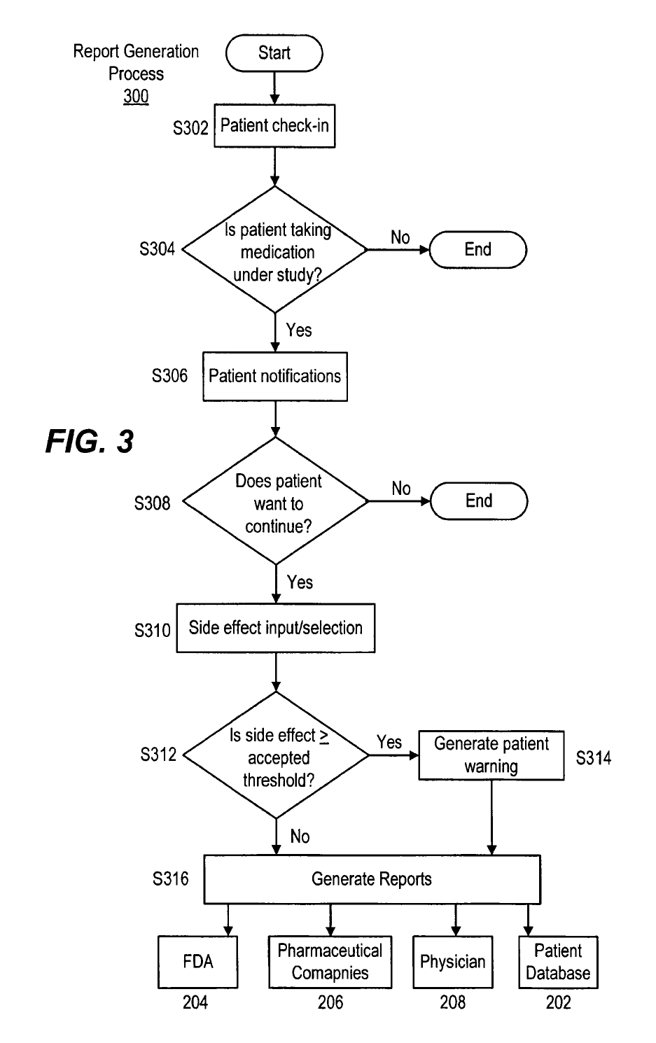

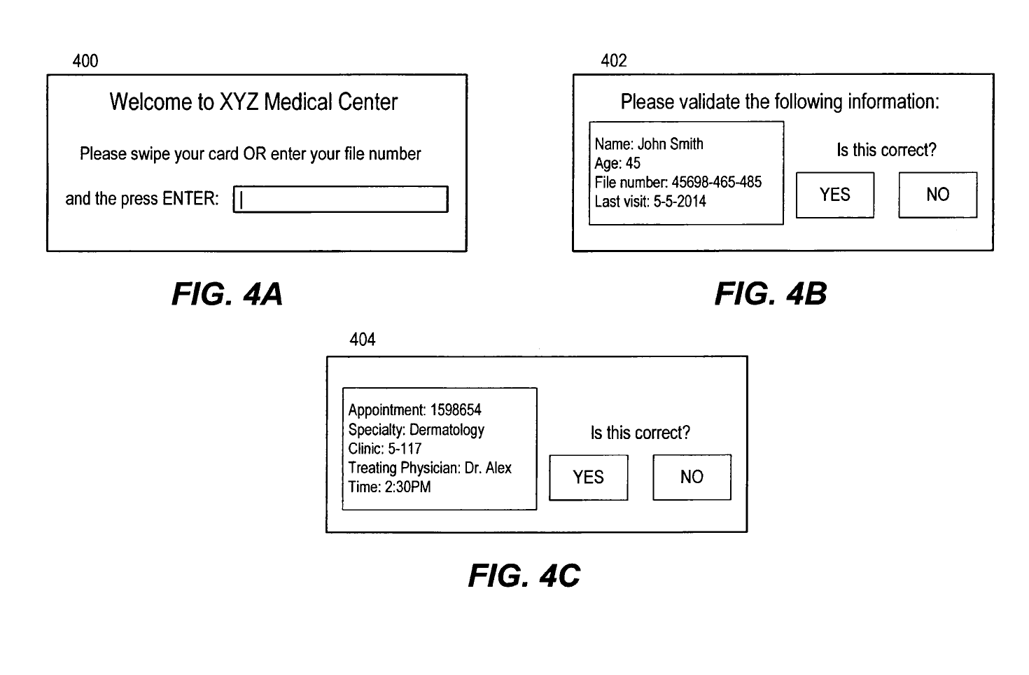

Next, FIG. 3 illustrates a non-limiting exemplary flowchart corresponding to a report generation process 300, according to certain embodiments. At step S302, patient check-in is executed at the voluntary reporting apparatus 100. The voluntary reporting apparatus 100 can include an interface, such as a keyboard and/or mouse, allowing a user, such as a patient, to input patient identification information, an appointment time, a doctor, and/or information pertaining to the condition the patient is being treated. FIGS. 4A-4C are exemplary illustrations of screens the patient may encounter while checking in at the voluntary reporting apparatus 100 according to certain embodiments. For example, FIG. 4A illustrates an exemplary initial check-in screen 400, according to certain embodiments. The voluntary reporting apparatus 100 can request the patient provide one or more of the following to confirm his or her identity: patient identification information, a file number, an appointment time, a doctor, and/or information pertaining to the condition for which the patient is being treated. The patient identification information can include name, age, birth date, last appointment date, treating physician, and/or primary ailment. In selected embodiments, the patient identification information can be retrieved from the patient database 202 by correlating a patient identification number, an identification card barcode, or biometric data such as a fingerprint with the patient identification information previously stored in the patient database 202.

FIG. 4B illustrates an exemplary patient information confirmation screen 402, according to certain embodiments. For example, after the patient swipes an identification card and/or inputs one or more types of the patient identification information, the patient may be asked to verify additional personal information to confirm his or her identity. At the information confirmation screen 402, the patient is asked to validate name, age, file number, and previous appointment date.

Next, FIG. 4C illustrates an exemplary appointment confirmation screen 404, according to certain embodiments. For example, in some implementations, after the patient confirms his or her identity at the patient information confirmation screen 402, the patient may be asked at the appointment confirmation screen 404 to confirm details pertaining to an upcoming appointment that can include, appointment confirmation number, specialty, clinic, physician, and appointment time.

Referring back to FIG. 3, at step S304, the processing circuitry determines whether the patient is taking a medication under study. After the patient has checked-in at the voluntary reporting apparatus 100, the patient database 202 is queried for the patient's medical record. In certain embodiments, the patient's medical record can include information such as medical history, details of previous appointments, and medications that the patient is currently taking. The patient database 202 also includes a list of medications that are under study that is compared to the medications that the patient is currently taking. If the patient's medical record indicates that the patient is taking one or more or the medications under study, resulting in a “yes” at step S304, the report generation process 300 continues to step S306. Otherwise, if the patient's medical record does not indicate that the patient is taking one or more of the medications under study, resulting in a “no” at step S304, the report generation process 300 is terminated.

In certain embodiments, whether step S304 results in a “yes” or a “no,” the information obtained at the patient check-in step of S302 is saved, and the patient is checked in for an upcoming appointment. Allowing the patient to check-in at the voluntary reporting apparatus 100 can minimize the need for office staff to manage a waiting area at a clinic or doctor's office. When the patient checks in at the voluntary reporting apparatus 100, the office staff can receive a notification via an interface at a computer regarding when patients have checked in for their appointments.

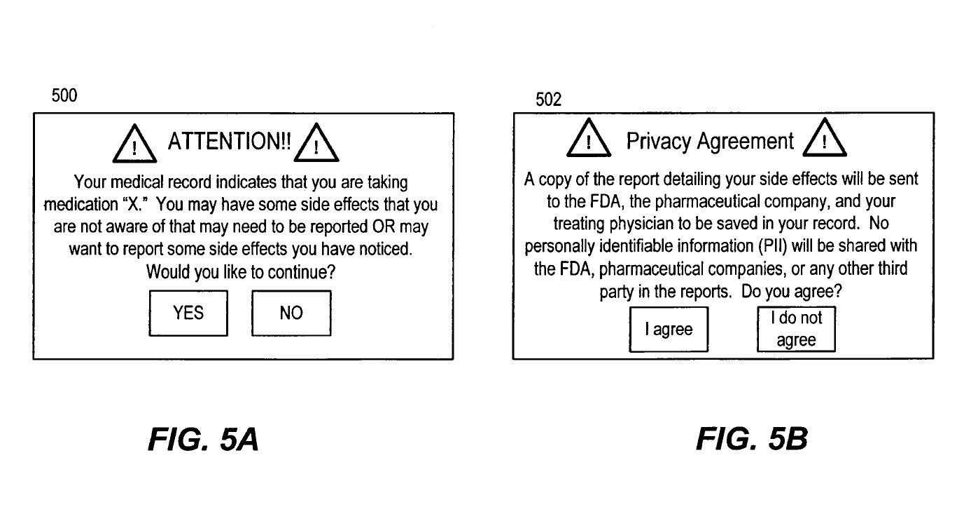

At step S306, if the patient is taking a medication under study, the patient is notified of his or her legal rights regarding the distribution of the reports pertaining to the side effects that are experienced due to the medication under study. In addition, the patient is also given the opportunity to provide consent to distributing reports pertaining to the side effects he or she is experiencing and can agree or disagree with continuing with the process. For example, FIGS. 5A-5B are exemplary illustrations of screens that the patient may encounter if taking a medication under study according to certain embodiments. FIG. 5A illustrates an exemplary patient permission screen 500, according to certain embodiments. In this example, at the patient permission screen 500, the patient is notified that he or she is taking a medication under study and may be experiencing side effects that can be reported. The patient can select at the interface whether or not the patient wishes to continue with reporting the side effects. If the patient selects “no,” indicating that the patient does not want to continue, the report generation process continues to step S308. If the patient selects “yes,” indicating that the patient wishes to continue, the patient is shown a legal notification.

FIG. 5B illustrates an exemplary legal notification screen 502, according to certain embodiments. In this example, the patient is shown a privacy agreement that states that a copy of the report detailing the side effects the patient is experiencing will be sent to the FDA, the pharmaceutical company, and the patient's physician and that no personally identifiable information (PIT) will be shared with anyone other than the patient's physician. Other legal provisions may be included based on laws, previous agreements, and/or policies of the pharmaceutical companies, FDA, or physicians.

Referring back to FIG. 3, at step S308, it is determined whether the patient is willing to proceed with providing the side effect information. If the patient selects “yes” at the patient permission screen 500 and “I agree” at the legal notification screen 502, then the result at step S308 is “yes,” and the report generation process 300 proceeds to step S310. Otherwise, if the patient selects “no” at the patient permission screen 500 or “I do not agree” at the legal notification screen 502, then the result at step S308 is “no,” the report generation process 300 is terminated.

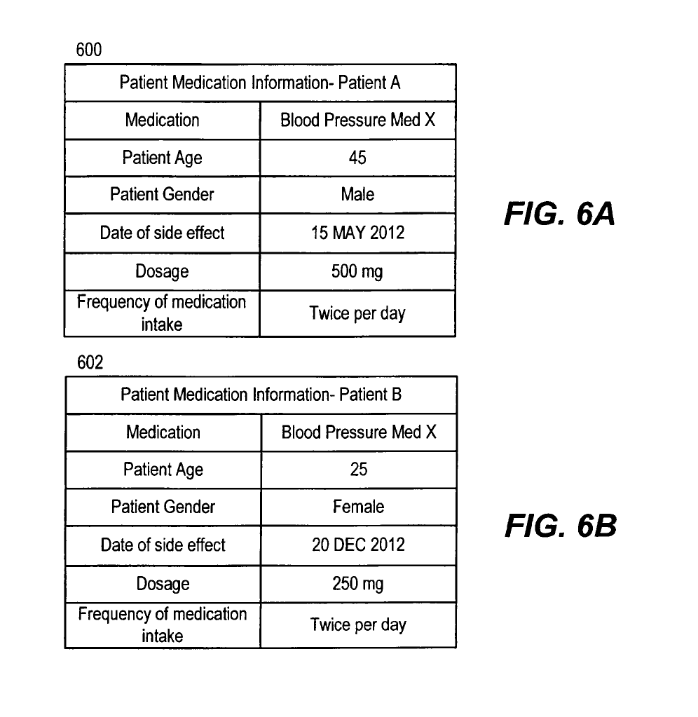

At step S310, the voluntary reporting apparatus 100 receives inputs and/or selections regarding the side effects that the patient is experiencing. When it is determined that the patient is taking a medication under study at step S304, a query of the patient database 202 is made by the processing circuitry to determine patient medication information within the patient's medical record regarding the medication under study. For example, FIGS. 6A and 6B are exemplary illustrations of the patient medication information for two exemplary patients, according to certain embodiments. FIG. 6A illustrates patient medication information 600 for Patient A, and FIG. 6B illustrates patient medication information 602 for Patient B. In the example, Patient A and Patient B are both taking a medication called “Blood Pressure Med X” which is under study. In addition to the type of medication, other factors that can influence the side effects are also stored in the patient database 202 that are included in the patient medication information 600 and 602. For example, the factors such as patient age, patient gender, date the side effect was experienced, dosage, and frequency can affect the side effects that the patient may experience.

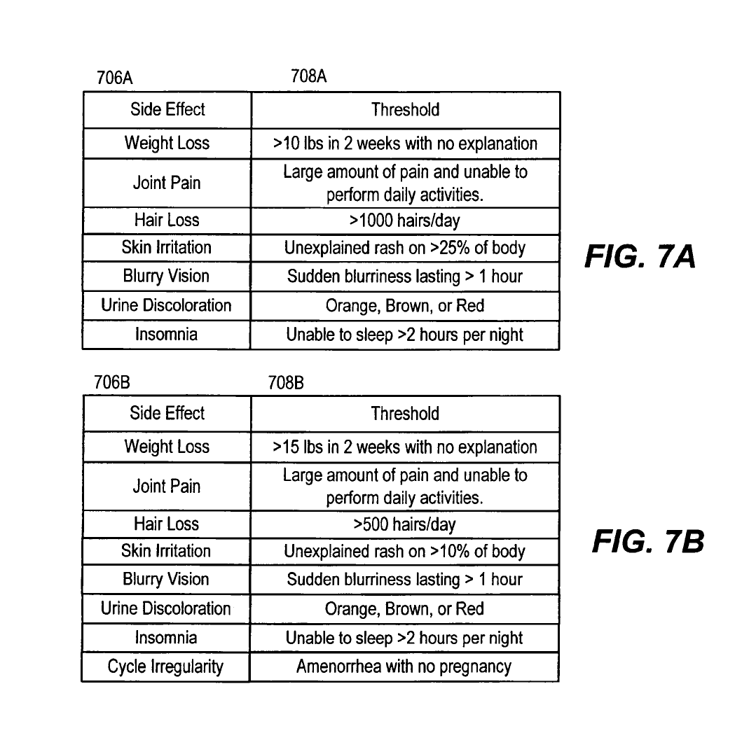

The patient medication information 600 and 602 are then used to modify the list of possible side effects that Patient A or Patient B can select. For example, FIGS. 7A and 7B are exemplary illustrations of side effect data that is stored in the patient database 202 regarding “Blood Pressure Med X” according to certain embodiments. FIG. 7A illustrates side effect data 706A for Patient A, and FIG. 7B illustrates side effect data 7B for Patient B. The side effect data 706A and 706B can include a list of the possible side effects that may be associated with the medication under study. The side effect data 706A and 706B can also be based on the patient medication information 600 and 602. For example, the side effect data 706A that is associated with the patient medication information 600 for Patient A can include weight loss, joint pain, hair loss, skin irritation, blurry vision, urine discoloration, and/or insomnia. In addition, the side effect data 706B for Patient B can include the additional side effect of cycle irregularity, which is based on the gender of Patient B being female. Accordingly, side effect data may be modified based on the known side effects for a medication the patient is taking in conjunction with information related to patient such as the patient medication information.

According to some embodiments, each side effect from the side effect data 706A and 706B can have an associated threshold 708A and 708B that indicates a severity of the side effect that can be dangerous to the patient. The patient medication information 600 and 602 can also be used to modify the threshold 708A and 708B associated with the side effect data 706A and 706B. For example, a severity level threshold for the side effect of weight loss may be affected by the age of the patient. As such, the severity level threshold associated with the side effect of weight loss may be >10 pounds in two weeks for a patient who is 45 years old, such as Patient A. For Patient B, who is 25 years old, the severity level threshold associated with the side effect of weight loss may be >15 pounds in two weeks.

In addition, the severity level threshold for the side effect of hair loss may be affected by the medication dosage. As such, the severity level threshold associated with the side effect of hair loss may be >1,000 hairs per day for a patient whose medication dosage is 500 mg, such as Patient A. For Patient B, whose medication dosage is 250 mg, the severity level threshold may be >500 hairs per day.

In addition, the severity level threshold for the side effect of skin irritation may be affected by a date or season of the year in which the side effect was experienced. As such, the severity level threshold associated with the side effect of skin irritation may be a rash on >25 of the body for a patient who experienced the side effect during the spring or summer, such as Patient A. For Patient B, who experienced the side effect of skin irritation during the fall or winter, the severity level threshold may be a rash on >10% of the body. For the remainder of the disclosure, side effect data 706A and associated threshold 708A for Patient A will be used for describing the report generation process 300. This is not intended to limit the scope, but rather to provide a more concise description.

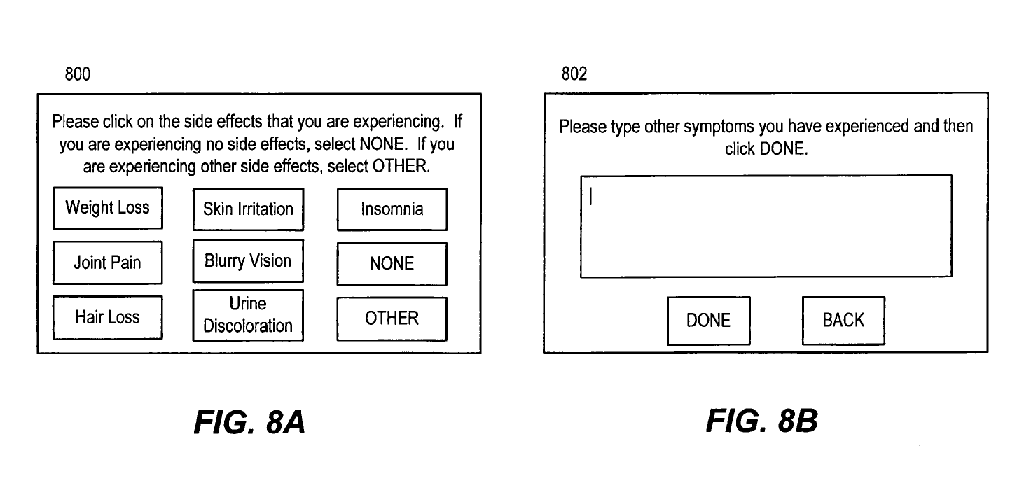

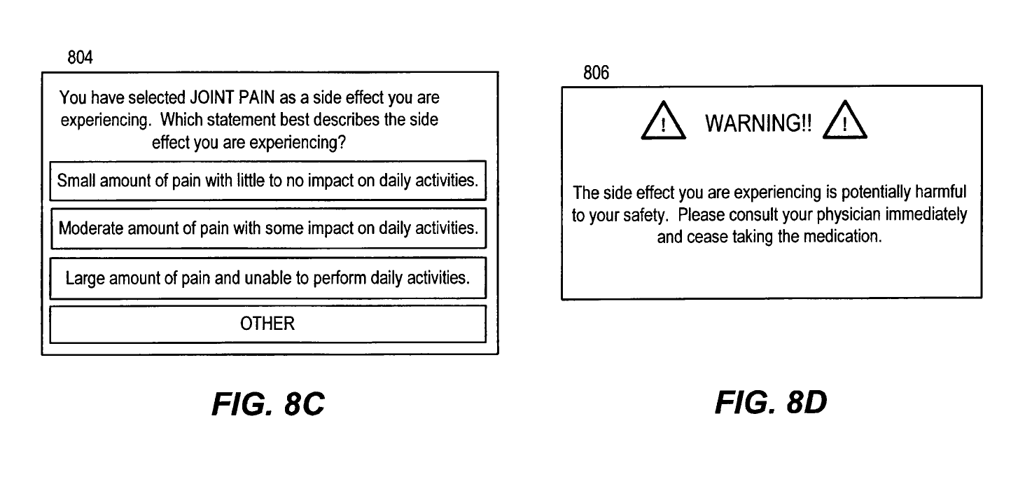

Once the list of the possible side effects has been determined, the patient can select and/or input the side effects that he or she has experienced while taking the medication under study. For example, FIGS. 8A and 8B are exemplary illustrations of screens that a patient may encounter during side effect input and/or selection at the voluntary reporting apparatus 100. FIG. 8A illustrates an exemplary side effect selection screen 800, according to certain embodiments. The side effect selection screen 800 can include the side effect data 706 as selections for the patient to choose. The patient can select at least one side effect from the side effect selection screen 800. If the patient is experiencing none of the side effects that are listed on the side effect selection screen 800, the patient can select NONE. If the patient is experiencing other side effects that are not listed on the side effect selection screen 800, the patient can select OTHER. In some aspects, the patient may not realize that he or she is experiencing a side effect related to the medication under study until the side effect selection screen 800 is encountered. FIG. 8B illustrates an exemplary side effect input screen 802, according to certain embodiments. The side effect input screen 802 allows the patient to input the side effects that are not listed on the side effect selection screen 800. For example, if the patient has been experiencing severe headaches since starting the medication, the patient can input that information at the side effect input screen 802.

Referring back to FIG. 3, at step S312, it is determined whether the one or more side effects that the patient is experiencing are greater than or equal to a severity level threshold. FIG. 8C illustrates an exemplary side effect severity screen 804, according to certain embodiments. For the side effect that is selected by the patient, choices are displayed on the side effect severity screen 804 that indicate different levels of severity for the side effect. For example, if the patient selects “joint pain” as the side effect, choices are displayed on the side effect severity screen 804 that indicate different levels of pain and impact on daily activities. In one example, the patient may select the choice at the side effect severity screen 804, “Large amount of pain and unable to perform daily activities.” In certain embodiments where the patient selects more than one side effect at the side effect section screen 800, the side effect severity screen 804 is displayed for each of the side effects that the patient selects.

The severity of the side effect that the patient selects at the side effect severity screen 804 can be compared to the threshold 708A associated with the side effect data 706A that indicates the severity of joint pain that may be dangerous to the patient. If the severity of the side effect is greater than or equal to the threshold 708A, resulting in a “yes,” the report generation process continues to step S314. Otherwise, if the severity of the side effect is less than the threshold 708A, resulting in a “no,” the report generation process continues to step S316. In the example of the patient who is experiencing joint pain that is classified as “Large amount of pain and unable to perform daily activities,” the severity is equal to the threshold 706A for joint pain so step S314 is executed.

Referring back to FIG. 3, at step S314, a patient warning is generated if a side effect he or she is experiencing is greater than a severity level threshold. FIG. 8D illustrates an exemplary side effect warning screen 806, according to certain embodiments. For example, the patient may receive a warning that the severity of the side effect is potentially harmful to the patient's safety. In addition, the patient can also be warned to consult the physician immediately and cease taking the medication. For the example of the joint pain that is equal to the severity level threshold, the side effect warning screen 806 is displayed to the patient at the voluntary reporting apparatus 100.

Referring back to FIG. 3, at step S316, side effect reports are generated. In some embodiments, the side effect reports can include the patient medication information 600, the side effects that the patient is experiencing, and the severity of the side effects. If the patient is experiencing a side effect with a severity that is greater than or equal to the threshold at step S312, the warning from step S314 can be included on the side effect reports to alert the physician, FDA, and/or pharmaceutical companies.

The voluntary reporting apparatus 100 can distribute the side effect reports via the network 10 to a variety of servers 104 that belong to one or more organizations that have an interest in knowing the information regarding the side effects that are related to the medication under study. For example, in certain embodiments, the side effect reports can be sent to the patient database 202 to be stored in the patient's medical record. In some implementations, the report can be distributed to the server of a food and drug administration 204 that may be responsible for approving the medication under study. For example, by directly receiving the side effect reports from the medications under study, the food and drug administration 204 is able to monitor the safety of the medications and evaluate their safety and effectiveness based on information provided directly from the patient.

In addition, the voluntary reporting apparatus 100 can distribute the side effect reports to the server of a pharmaceutical company 206 that developed the medication under study. For example, by directly receiving the side effect reports, the pharmaceutical company 206 can study the medications in light of the side effects reported by the patients who are taking the medications. In some implementations, the pharmaceutical company 206 can confirm the causes of the side effects, alter the composition of medications based on the reported side effects, and develop new drugs based on knowledge gained from knowing the side effects associated with the medications. In addition, the pharmaceutical company 206 can also use the patient side effect information from the side effect reports to assist in finding new applications for drugs that have already been developed. In certain embodiments, by sending the same reports to the pharmaceutical company 206 and the food and drug administration 204, there is an increase in transparency between pharmaceutical company 206 and the food and drug administration 204, which can decrease an amount of fraudulent reporting.

The voluntary reporting apparatus 100 can also distribute the side effect reports to the server of a healthcare provider, such as a physician 208 or other medical professional who is providing medical services to the patient. For example, by directly receiving the side effect reports, the physician 208 can evaluate the side effects the patient is experiencing and correlate them with the medication under study that the patient is taking. In addition, questioning the patient at the self-check-in kiosk 200 regarding the side effects associated with the medication under study prior to an appointment adds redundancy to ensure that the physician does not forget to question the patient regarding the side effects. In one implementation, the patient can use an application on his or her Smart Phone to report a side effect that immediately is sent to the physician 208.

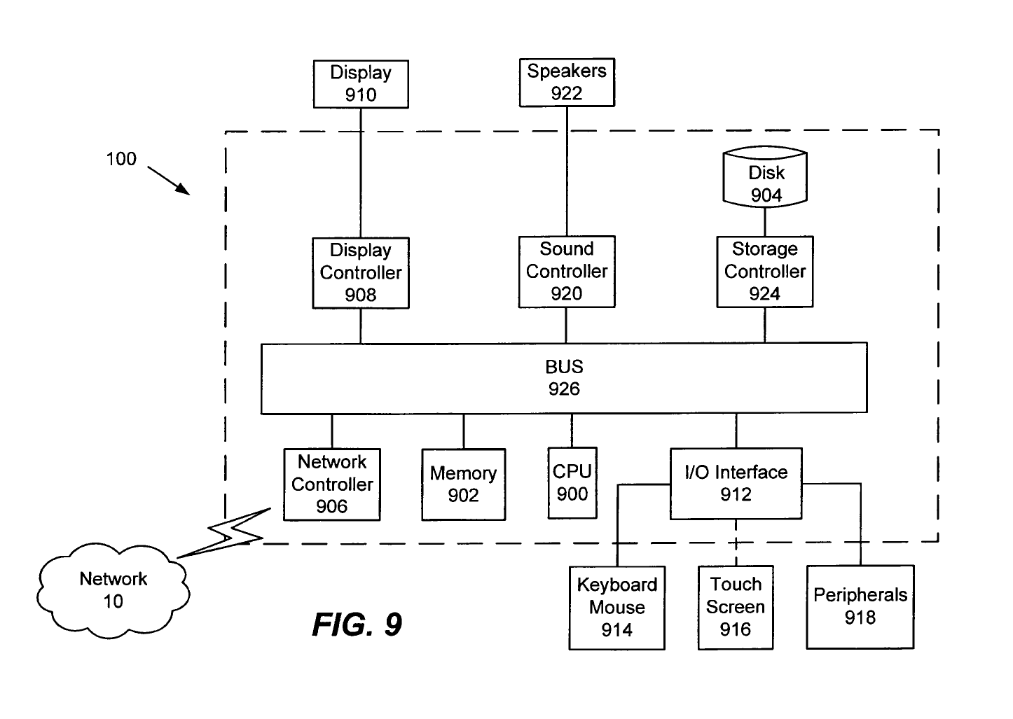

A hardware description of the voluntary reporting apparatus 100 according to exemplary embodiments is described with reference to FIG. 9. In FIG. 9, the voluntary reporting apparatus 10 includes a CPU 900 that performs the processes described herein. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the voluntary reporting apparatus 100 communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The voluntary reporting apparatus 100 in FIG. 9 also includes a network controller 906, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The voluntary reporting apparatus 100 further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface 912 also connects to a variety of peripherals 918 including printers and scanners, such as an OfficeJet or DeskJet from Hewlett Packard.

A sound controller 920 is also provided in the voluntary reporting apparatus 100, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the voluntary reporting apparatus 100. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

In other alternate embodiments, processing features according to the present disclosure may be implemented and commercialized as hardware, a software solution, or a combination thereof. Moreover, instructions corresponding to report generation process in accordance with the present disclosure could be stored in a thumb drive that hosts a secure process for generating the side effect reports. Further, aspects of the present disclosure may be implemented as a trusted operating system process or typing mode.

Obviously, numerous modifications and variations of the present disclosure are possible in light of the above teachings. It is therefore to be understood that within the scope of the appended claims, the invention may be practiced otherwise than as specifically described herein. For example, advantageous results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable processing circuits configured to execute program code and/or computer instructions to execute the functions, processes and algorithms described herein. A processing circuit includes a programmed processor, as a processor includes circuitry. A processing circuit also includes devices such as an application specific integrated circuit (ASIC) and conventional circuit components arranged to perform the recited functions.

The functions and features described herein may also be executed by various distributed components of a system. For example, one or more processors may execute these system functions, wherein the processors are distributed across multiple components communicating in a network. The distributed components may include one or more client and/or server machines, in addition to various human interface and/or communication devices (e.g., display monitors, smart phones, tablets, personal digital assistants (PDAs)). The network may be a private network, such as a LAN or WAN, or may be a public network, such as the Internet. Input to the system may be received via direct user input and/or received remotely either in real-time or as a batch process. Additionally, some implementations may be performed on modules or hardware not identical to those described. Accordingly, other implementations are within the scope that may be claimed.

The above disclosure also encompasses the embodiments noted below.

(1) A voluntary reporting apparatus for performing report generation, the apparatus including: circuitry configured to receive patient identification information at a check-in interface; determine whether a patient is taking at least one medication under study; receive, as one or more selections and/or inputs, in response to determining that the patient is taking the at least one medication under study, at least one side effect experienced by the patient related to the at least one medication under study; compare at least one severity level related to the at least one experienced side effect to at least one severity level threshold; and generate one or more reports that include the at least one experienced side effect and the at least one severity level related to the at least one medication under study.

(2) The voluntary reporting apparatus of (1), wherein the circuitry is further configured to identify the patient based on the patient identification information.

(3) The voluntary reporting apparatus of (1) or (2), wherein the circuitry is further configured to store, in at least one database, a plurality of medical records and side effect data for the at least one medication under study.

(4) The voluntary reporting apparatus of any one of (1) to (3), wherein the plurality of medical records includes patient medication information.

(5) The voluntary reporting apparatus of any one of (1) to (4), wherein the circuitry is further configured to query the at least one database to determine at least one medication that the patient is taking.

(6) The voluntary reporting apparatus of any one of (1) to (5), wherein the circuitry is further configured to compare the at least one medication that the patient is taking to the at least one medication under study.

(7) The voluntary reporting apparatus of any one of (1) to (6), wherein the circuitry is further configured to notify the patient that the patient is taking the at least one medication under study.

(8) The voluntary reporting apparatus of any one of (1) to (7), wherein the circuitry is further configured to receive permission from the patient to obtain the at least one side effect related to the at least one medication under study.

(9) The voluntary reporting apparatus of any one of (1) to (8), wherein the circuitry is further configured to output a warning if the at least one severity level is greater than or equal to the at least one severity level threshold.

(10) The voluntary reporting apparatus of any one of (1) to (9), wherein the side effect data includes at least one potential side effect and the at least one severity level threshold.

(11) The voluntary reporting apparatus of any one of (1) to (10), wherein the severity level threshold associated with the side effect data corresponds to the at least one severity level indicating a level at which the at least one side effect becomes dangerous to the patient.

(12) The voluntary reporting apparatus of any one of (1) to (11), wherein the circuitry is further configured to modify the side effect data based on the patient medication information.

(13) The voluntary reporting apparatus of any one of (1) to (12), wherein at least one of the side effect data and the severity level threshold is modified based on at least one of an age and gender of the patient.

(14) The voluntary reporting apparatus of any one of (1) to (13), wherein at least one of the side effect data and the severity level threshold is modified based on at least one of a medication dosage, a frequency of intake, and a date when the at least one side effect was experienced by the patient.

(15) The voluntary reporting apparatus of any one of (1) to (14), wherein the circuitry is further configured to receive, as the selection or input, the at least one severity level related to the at least one experienced side effect.

(16) The voluntary reporting apparatus of any one of (1) to (15), wherein the circuitry is further configured to distribute the one or more reports to one or more external entities.

(17) The voluntary reporting apparatus of any one of (1) to (16), wherein the circuitry is further configured to store the one or more reports in at least one database.

(18) The voluntary reporting apparatus of any one of (1) to (17), wherein the one or more reports include a warning if the at least one severity level is greater than or equal to the severity level threshold.

(19) A non-transitory computer-readable medium having computer-readable instructions thereon which when executed by a computer cause the computer to perform a method for report generation, the method including: receiving patient identification information at a check-in interface; determining whether a patient is taking at least one medication under study; receiving, as one or more selections and/or inputs, in response to determining that the patient is taking the at least one medication under study, at least one experienced side effect related to the at least one medication under study; comparing at least one severity level related to the at least one experienced side effect to at least one predetermined severity level threshold; and generating one or more reports that include the at least one experienced side effect and the at least one severity level related to the at least one medication under study.

(20) A method for report generation, the method including: receiving patient identification information at a check-in interface; determining whether a patient is taking at least one medication under study; receiving, as one or more selections and/or inputs, in response to determining that the patient is taking the at least one medication under study, at least one experienced side effect related to the at least one medication under study; comparing, via processing circuitry, at least one severity level related to the at least one experienced side effect to at least one predetermined severity level threshold; and generating one or more reports that include the at least one experienced side effect and the at least one severity level related to the at least one medication under study.

1. A voluntary reporting apparatus for performing report generation, the apparatus comprising:
circuitry configured to:
receive patient identification information at a check-in interface,
determine whether a patient is taking at least one medication under study,
receive, as one or more selections and/or inputs, in response to determining that the patient is taking the at least one medication under study, at least one side effect experienced by the patient related to the at least one medication under study,
compare at least one severity level related to the at least one experienced side effect to at least one severity level threshold, and
generate one or more reports that include the at least one experienced side effect and the at least one severity level related to the at least one medication under study.

2. The voluntary reporting apparatus of claim 1, wherein the circuitry is further configured to identify the patient based on the patient identification information.

3. The voluntary reporting apparatus of claim 1, wherein the circuitry is further configured to store, in at least one database, a plurality of medical records and side effect data for the at least one medication under study.

4. The voluntary reporting apparatus of claim 3, wherein the plurality of medical records includes patient medication information.

5. The voluntary reporting apparatus of claim 4, wherein the circuitry is further configured to query the at least one database to determine at least one medication that the patient is taking.

6. The voluntary reporting apparatus of claim 5, wherein the circuitry is further configured to compare the at least one medication that the patient is taking to the at least one medication under study.

7. The voluntary reporting apparatus of claim 6, wherein the circuitry is further configured to notify the patient that the patient is taking the at least one medication under study.

8. The voluntary reporting apparatus of claim 1, wherein the circuitry is further configured to receive permission from the patient to obtain the at least one side effect related to the at least one medication under study.

9. The voluntary reporting apparatus of claim 1, wherein the circuitry is further configured to output a warning if the at least one severity level is greater than or equal to the at least one severity level threshold.

10. The voluntary reporting apparatus of claim 3, wherein the side effect data includes at least one potential side effect and the at least one severity level threshold.

11. The voluntary reporting apparatus of claim 10, wherein the severity level threshold associated with the side effect data corresponds to the at least one severity level indicating a level at which the at least one side effect becomes dangerous to the patient.

12. The voluntary reporting apparatus of claim 11, wherein the circuitry is further configured to modify the side effect data based on the patient medication information.

13. The voluntary reporting apparatus of claim 12, wherein at least one of the side effect data and the severity level threshold is modified based on at least one of an age and gender of the patient.

14. The voluntary reporting apparatus of claim 13, wherein at least one of the side effect data and the severity level threshold is modified based on at least one of a medication dosage, a frequency of intake, and a date when the at least one side effect was experienced by the patient.

15. The voluntary reporting apparatus of claim 1, wherein the circuitry is further configured to receive, as the selection or input, the at least one severity level related to the at least one experienced side effect.

16. The voluntary reporting apparatus of claim 1, wherein the circuitry is further configured to distribute the one or more reports to one or more external entities.

17. The voluntary reporting apparatus of claim 2, wherein the circuitry is further configured to store the one or more reports in at least one database.

18. The voluntary reporting apparatus of claim 1, wherein the one or more reports include a warning if the at least one severity level is greater than or equal to the severity level threshold.

19. A non-transitory computer-readable medium having computer-readable instructions thereon which when executed by a computer cause the computer to perform a method for report generation, the method comprising:
receiving patient identification information at a check-in interface;
determining whether a patient is taking at least one medication under study;
receiving, as one or more selections and/or inputs, in response to determining that the patient is taking the at least one medication under study, at least one experienced side effect related to the at least one medication under study;
comparing at least one severity level related to the at least one experienced side effect to at least one predetermined severity level threshold; and
generating one or more reports that include the at least one experienced side effect and the at least one severity level related to the at least one medication under study.

20. A method for report generation, the method comprising:
receiving patient identification information at a check-in interface;
determining whether a patient is taking at least one medication under study;
receiving, as one or more selections and/or inputs, in response to determining that the patient is taking the at least one medication under study, at least one experienced side effect related to the at least one medication under study;
comparing, via processing circuitry, at least one severity level related to the at least one experienced side effect to at least one predetermined severity level threshold; and
generating one or more reports that include the at least one experienced side effect and the at least one severity level related to the at least one medication under study.
